(19) United States
(12) Patent Application Publication
(10) Pub. No.: US 2024/0267911 A1
(43) Pub. Date: Aug. 8, 2024

(54) METHODS AND APPARATUSES FOR HANDLING CONFIGURED GRANT INFORMATION

(71) Applicant: Lenovo (Beijing) Limited, Beijing (CN)

(72) Inventors: Congchi Zhang, Shanghai (CN); Lianhai Wu, Beijing (CN); Ran Yue, Beijing (CN); Mingzeng Dai, Shanghai (CN); Le Yan, Shanghai (CN)

(73) Assignee: Lenovo (Beijing) Limited, Beijing (CN)

(21) Appl. No.: 18/290,213

(22) PCT Filed: May 10, 2021
(86) PCT No.: PCT/CN2021/092657

§ 371 Date: Nov. 10, 2023

(51) Int. Cl. H04W 72/1268; H04W 76/15; H04W 76/30

(52) U.S. Cl. CPC H04W 72/1268; H04W 76/15; H04W 76/30

(57) ABSTRACT

Embodiments of the present application relate to methods and apparatuses for handling configured grant (CG) information when a secondary cell group (SCG) is deactivated in a multi-radio dual connectivity (MR-DC) scenario under a 3rd Generation Partnership Project (3GPP) 5G New Radio (NR) system or the like. According to an embodiment of the present application, a method may be performed by a UE and can include: receiving CG information from a network, wherein the CG information is for an uplink transmission from the UE to the network, and wherein the CG information is associated with a primary secondary cell (PSCell) of a SCG in relation to the UE; and in response to deactivation of the SCG, handling the CG information by at least one of: releasing the CG information from the UE; suspending the CG information in the UE; and maintaining the CG information in the UE.

### TECHNICAL FIELD

Embodiments of the present application generally relate to wireless communication technology, especially to methods and apparatuses for handling configured grant (CG) information when a secondary cell group (SCG) is deactivated in a multi-radio dual connectivity (MR-DC) scenario.

### BACKGROUND

Next generation radio access network (NG-RAN) supports a MR-DC operation. In the MR-DC operation, a user equipment (UE) with multiple transceivers may be configured to utilize resources provided by two different nodes connected via non-ideal backhauls. Wherein one node may provide NR access and the other one node may provide either evolved-universal mobile telecommunication system (UMTS) terrestrial radio access (UTRA) (E-UTRA) or NR access. One node may act as a master node (MN), and the other node may act as a secondary node (SN). The MN and SN are connected via a network interface (for example, Xn interface as specified in 3rd Generation Partnership Project (3GPP) standard documents), and at least the MN is connected to the core network.

As defined in 3GPP standard document TS38.321, there are two types of transmission without dynamic grant: (1) configured grant (CG) Type 1, where an uplink grant is provided by radio resource control (RRC) signalling, and stored as configured uplink grant; and (2) configured grant (CG) Type 2, where an uplink grant is provided by a physical downlink control channel (PDCCH), and stored or cleared as configured uplink grant based on L1 signalling indicating configured uplink grant activation or deactivation. “CG Type 1” and “CG Type 2” are configured by RRC signalling per a serving cell and per a bandwidth part (BWP). Multiple configurations can be active simultaneously in the same BWP. For “CG Type 2”, activation and deactivation are independent among the serving cells. For the same BWP, a medium access control (MAC) entity can be configured with both “CG Type 1” and “CG Type 2”.

As defined in 3GPP standard document TS38.321, RRC signalling may configure at least one of following parameters when “CG Type 1” is configured: cs-RNTI; periodicity; time DomainOffset; time DomainAllocation; nrofHARQ-Processes; harq-ProcID-Offset; harq-ProcID-Offset2; and timeReferenceSFN. In addition, RRC signalling may configure at least one of following parameters when “CG Type 2” is configured: cs-RNTI; periodicity; nrofHARQ-Processes; harq-ProcID-Offset; and harq-ProcID-Offset2.

Parameter(s) configured by RRC signalling for CG may be named as “CG information”, “CG configuration information”, “CG related information”, “configuration information regarding CG” “information regarding CG”, “CG configuration parameter(s)”, “CG parameter(s)”, “CG related parameter(s)”, or the like.

Parameter(s) configured by RRC signalling for “CG Type 1” may be named as “Type 1 CG”, “Type 1 CG information”, “Type 1 CG configuration information”, “configuration information regarding CG Type 1” “information regarding CG Type 1”, “CG Type 1 information”, “CG Type 1 related information”, “CG Type 1 configuration parameter(s)”, “CG Type 1 parameter(s)”, “CG Type 1 related parameter(s)”, or the like. Similarly, parameter(s) configured by RRC signalling for “CG Type 2” may be named as “Type 2 CG”, “Type 2 CG information”, “Type 2 CG configuration information”, or other possible expressions.

In a 3GPP 5G system or network, a UE may receive CG configuration information. However, details regarding handling CG information when a SCG is deactivated in a MR-DC scenario have not been discussed in 3GPP 5G technology yet.

### SUMMARY

Some embodiments of the present application provide a method for wireless communications. The method may be performed by a UE. The method includes: receiving CG information from a network, wherein the CG information is for an uplink transmission from the UE to the network, and wherein the CG information is associated with a primary secondary cell (PSCell) of a secondary cell group (SCG) in relation to the UE; and in response to deactivation of the SCG, handling the CG information by at least one of: releasing the CG information from the UE; suspending the CG information in the UE; and maintaining the CG information in the UE.

Some embodiments of the present application also provide a UE. The UE includes a processor and a wireless transceiver coupled to the processor; and the processor is configured: to receive, via the wireless transceiver, CG information from the network, wherein the CG information is for an uplink transmission from the UE to the network, and wherein the CG information is associated with a PSCell of a SCG in relation to the UE; and in response to deactivation of the SCG, to handle the CG information by at least one of: releasing the CG information from the UE; suspending the CG information in the UE; and maintaining the CG information in the UE.

Some embodiments of the present application also provide an apparatus for wireless communications. The apparatus includes: a non-transitory computer-readable medium having stored thereon computer-executable instructions; a receiving circuitry; a transmitting circuitry; and a processor coupled to the non-transitory computer-readable medium, the receiving circuitry and the transmitting circuitry, wherein the computer-executable instructions cause the processor to implement any of the above-mentioned methods performed by a UE.

Some embodiments of the present application provide a further method for wireless communications. The method may be performed by a network device (e.g., a MN and/or a SN). The method includes: transmitting CG information to a UE, wherein the CG information is for an uplink transmission from the UE to the network device, and wherein the CG information is associated with a PSCell of a SCG in relation to the UE; and in response to deactivation of the SCG, transmitting a network message to the UE for indicating the deactivation of the SCG.

Some embodiments of the present application also provide a network device (e.g., a MN and/or a SN). The UE includes a processor and a wireless transceiver coupled to the processor; and the processor is configured: to transmit, via the wireless transceiver, CG information to a UE, wherein the CG information is for an uplink transmission from the UE, and wherein the CG information is associated with a PSCell of a SCG in relation to the UE; and to transmit, via the wireless transceiver, a network message to the UE for indicating deactivation of the SCG, in response to the deactivation of the SCG.

Some embodiments of the present application also provide an apparatus for wireless communications. The apparatus includes: a non-transitory computer-readable medium having stored thereon computer-executable instructions; a receiving circuitry; a transmitting circuitry; and a processor coupled to the non-transitory computer-readable medium, the receiving circuitry and the transmitting circuitry, wherein the computer-executable instructions cause the processor to implement any of the above-mentioned methods performed by a network device (e.g., a MN and/or a SN).

The details of one or more examples are set forth in the accompanying drawings and the descriptions below. Other features, objects, and advantages will be apparent from the descriptions and drawings, and from the claims.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 illustrates a schematic diagram of a wireless communication system in accordance with some embodiments of the present application;

FIG. 2 illustrates an exemplary flow chart of a method for receiving CG information in accordance with some embodiments of the present application;

FIG. 3 illustrates an exemplary flow chart of a method for transmitting CG information in accordance with some embodiments of the present application;

FIG. 4 illustrates an exemplary flowchart of handling CG information in accordance with some embodiments of the present application;

FIG. 5 illustrates a further exemplary flowchart of handling CG information in accordance with some embodiments of the present application;

FIG. 6 illustrates another exemplary flowchart of handling CG information in accordance with some embodiments of the present application; and

FIG. 7 illustrates an exemplary block diagram of an apparatus according to some embodiments of the present application.

### DETAILED DESCRIPTION

The detailed description of the appended drawings is intended as a description of preferred embodiments of the present application and is not intended to represent the only form in which the present application may be practiced. It should be understood that the same or equivalent functions may be accomplished by different embodiments that are intended to be encompassed within the spirit and scope of the present application.

Reference will now be made in detail to some embodiments of the present application, examples of which are illustrated in the accompanying drawings. To facilitate understanding, embodiments are provided under specific network architecture and new service scenarios, such as 3GPP 5G, 3GPP LTE Release 8 and so on. It is contemplated that along with developments of network architectures and new service scenarios, all embodiments in the present application are also applicable to similar technical problems; and moreover, the terminologies recited in the present application may change, which should not affect the principle of the present application.

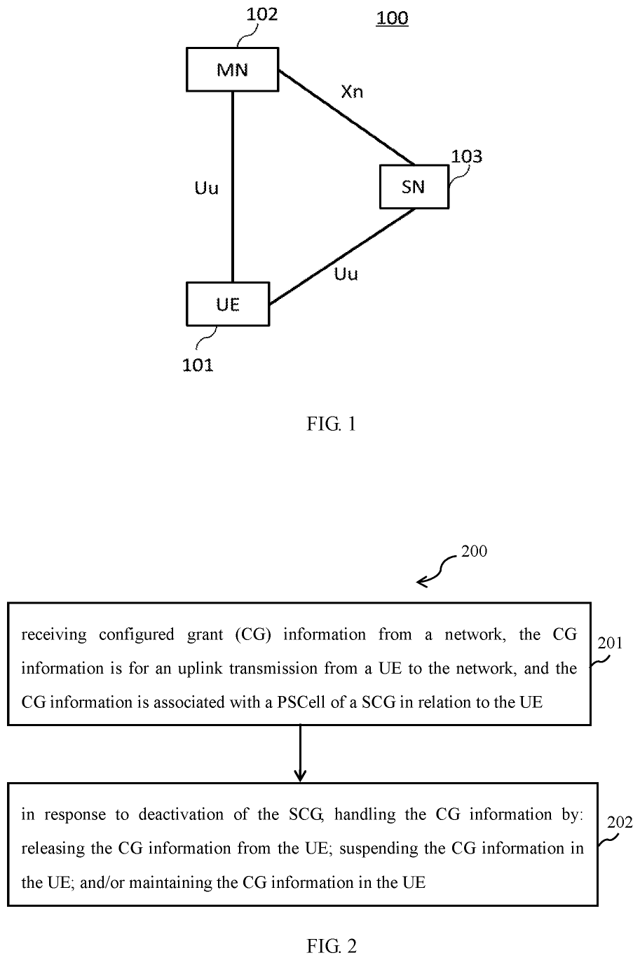

FIG. 1 illustrates a schematic diagram of a wireless communication system in accordance with some embodiments of the present application.

As shown in FIG. 1, the wireless communication system 100 may be a dual connectivity system 100, including at least one UE 101, at least one MN 102, and at least one SN 103. In particular, the dual connectivity system 100 in FIG. 1 includes one shown UE 101, one shown MN 102, and one shown SN 103 for illustrative purpose. Although a specific number of UEs 101, MNs 102, and SNs 103 are depicted in FIG. 1, it is contemplated that any number of UEs 101, MNs 102, and SNs 103 may be included in the wireless communication system 100.

Referring to FIG. 1, UE 101 may be connected to MN 102 and SN 103 via a network interface, for example, the Uu interface as specified in 3GPP standard documents. MN 102 and SN 103 may be connected with each other via a network interface, for example, the Xn interface as specified in 3GPP standard documents. MN 102 may be connected to the core network via a network interface (not shown in FIG. 1). UE 102 may be configured to utilize resources provided by MN 102 and SN 103 to perform data transmission.

MN 102 may refer to a radio access node that provides a control plane connection to the core network. In an embodiment of the present application, in the E-UTRA-NR Dual Connectivity (EN-DC) scenario, MN 102 may be an eNB. In another embodiment of the present application, in the next generation E-UTRA-NR Dual Connectivity (NGEN-DC) scenario, MN 102 may be an ng-eNB. In yet another embodiment of the present application, in the NR-E-UTRA Dual Connectivity (NE-DC) scenario or the NR-NR Dual Connectivity (NR-DC) scenario, MN 102 may be a gNB.

MN 102 may be associated with a master cell group (MCG). The MCG may refer to a group of serving cells associated with MN 102, and may include a primary cell (PCell) and optionally one or more secondary cells (SCells) of the MCG. The PCell may provide a control plane connection to UE 101.

SN 103 may refer to a radio access node without a control plane connection to the core network but providing additional resources to UE 101. In an embodiment of the present application, in the EN-DC scenario, SN 103 may be an en-gNB. In another embodiment of the present application, in the NE-DC scenario, SN 103 may be a ng-eNB. In yet another embodiment of the present application, in the NR-DC scenario or the NGEN-DC scenario, SN 103 may be a gNB.

SN 103 may be associated with a secondary cell group (SCG). The SCG may refer to a group of serving cells associated with SN 103, and may include a primary secondary cell (PSCell) and optionally one or more SCells. The PCell of the MCG and the PSCell of the SCG may also be referred to as a special cell (SpCell).

In some embodiments of the present application, UE 101 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. In some other embodiments of the present application, UE 101 may include a portable wireless communication device, a smart phone, a cellular telephone, a flip phone, a device having a subscriber identity module, a personal computer, a selective call receiving circuitry, or any other device that is capable of sending and receiving communication signals on a wireless network. In some other embodiments of the present application, UE 101 may include wearable devices, such as smart watches, fitness bands, optical head-mounted displays, or the like. Moreover, UE 101 may be referred to as a subscriber unit, a mobile, a mobile station, a user, a terminal, a mobile terminal, a wireless terminal, a fixed terminal, a subscriber station, a user terminal, or a device, or described using other terminology used in the art.

According to agreements of 3GPP standard documents, Release 17 work item on NR supports an efficient SCG activation or deactivation procedure in a MR-DC scenario. In an EN-DC deployment, power consumptions of a UE and a network are a big issue, due to maintaining two radio links simultaneously. In some cases, a NR UE power consumption is 3 to 4 times higher than LTE. In an EN-DC deployment, a MN provides the basic coverage. When a UE's data rate requirement changes dynamically, e.g., from high to low, a SN is worth considering to be (de)activated to save energy consumptions of the network and the UE.

According to agreements of 3GPP standard documents, a SCG deactivation can be triggered by a network device (e.g., either a MN and/or a SN). When a UE receives a command from the network device to deactivate the SCG, the UE will stop monitoring a PDCCH transmission, and stop any physical uplink share channel (PUSCH) transmission. However, currently, it is unclear how to handle CG information (e.g., Type 1 CG information), which has been configured for the SCG; and it is unclear how to handle the CG information if the network device provides new CG information (e.g., new Type 1 CG information) for the SCG when the SCG is currently deactivated.

Embodiments of the present application provide methods to handle CG information (e.g., Type 1 CG information) when a SCG is deactivated. Embodiments of the present application assume that a UE is connected to a MN and a SN, i.e., in a MR-DC scenario.

In some embodiments of the present application, a UE receives a message from a network device (a MN and/or a SN), and the message indicates SCG deactivation. The received message may be either RRC signalling, a medium access control (MAC) control element (CE), or downlink control information (DCI). In some embodiments of the present application, if CG information (e.g., Type 1 CG information) has been configured before deactivation of a SCG, or if the CG information is provided after the deactivation of the SCG, a UE may: (1) immediately clear (or release) all the CG information associated with a PSCell of the SCG; (2) suspend all the CG information associated with the PSCell of the SCG, and re-initialize the suspended CG information upon an indication from a network device; and/or (3) maintain all the CG information associated the PSCell of the SCG, and can use the maintained CG information to transmit uplink data, wherein the UL data indicates that activation of the SCG is triggered by the UE. In general, the CG information (e.g., Type 1 CG information) can be used to achieve a fast activation of the SCG or send data immediately after the activation of the SCG.

In embodiments of the present application, suspending CG information means CG configuration or parameters are stored, while the CG information is not used for any uplink transmission; clearing CG information means CG configuration or parameters are all released; and maintaining CG information means CG configuration or parameters can be used for an uplink transmission. Clearing CG information may also be named as releasing CG information in some cases. More details will be illustrated in the following text in combination with the appended drawings.

FIG. 2 illustrates an exemplary flow chart of a method for receiving CG information in accordance with some embodiments of the present application. The exemplary method 200 in the embodiments of FIG. 2 may be performed by a UE (e.g., UE 101, UE 410, UE 510, or UE 610 as shown and illustrated in any of FIGS. 1 and 4-6). Although described with respect to a UE, it should be understood that other devices may be configured to perform a method similar to that of FIG. 2.

In the exemplary method 200 as shown in FIG. 2, in operation 201, a UE (e.g., UE 101 as illustrated and shown in FIG. 1) receives CG information from a network (e.g., MN 102 or SN 103 as illustrated and shown in FIG. 1). The CG information is for an uplink transmission from the UE to the network, and the CG information is associated with a PSCell of a SCG in relation to the UE. In operation 202, in response to deactivation of the SCG, the UE handles the CG information by: releasing the CG information from the UE; suspending the CG information in the UE; and/or maintaining the CG information in the UE.

According to some embodiments, the CG information relates to type 1 CG. That is, the UE may receive Type 1 CG information from the network in operation 201. According to some other embodiments, the CG information relates to type 2 CG.

According to some embodiments, the UE may receive a network message from the network, and the network message includes a command for deactivating the SCG. This network message may be marked as “1st network message” for short. For example, the 1st network message is a radio resource control (RRC) message. In an embodiment, the CG information is received before receiving the 1st network message. That is, the UE firstly receives the CG information and then receives the 1st network message. In a further embodiment, the CG information is received after receiving the 1st network message. That is, the UE firstly receives the 1st network message and then receives the CG information.

In some embodiments, upon receiving the 1st network message, the UE releases the CG information, suspends the CG information; or maintains the CG information. Details of these embodiments are described below.

In an embodiment, the operation of “the UE releases the CG information” further comprises releasing additional CG information, and the additional CG information is associated with one or more SCells of the SCG. For instance, after releasing the CG information, the UE releases additional CG information which is associated with SCell(s) of the SCG.

In a further embodiment, the operation of “the UE suspends the CG information” further comprises releasing the CG information in response to: (1) an expiry of a time alignment timer (TAT) associated with the PSCell; (2) detecting a beam failure; and/or (3) detecting a radio link failure (RLF). For instance, after suspending the CG information, the UE further releasing the CG information in response to: an expiry of a TAT associated with the PSCell; detecting a beam failure; and/or detecting a RLF.

In an additional embodiment, the operation of “the UE suspends the CG information” further comprises reinitializing the CG information, if the CG information is not released from the UE. For instance, the CG information may be reinitialized in response to one of following conditions:
Condition (1): receiving a further network message from the network, and determining that a TAT associated with the PSCell is running, and the further network message includes a command for (re-)activating the SCG. The further network message may be marked as “2nd network message” for short. For example, Condition (1) refers to a network triggered SCG (re-)activation procedure.
·Condition (2): an arrival of uplink data at a radio bearer of the SCG, and determining that the TAT associated with the PSCell is running. For example, Condition (2) refers to a UE triggered SCG (re-)activation procedure.

In the abovementioned additional embodiment, the UE may transmit a scheduling request (SR) to the network and receive an additional network message from the network, and the additional network message indicates a reinitialization of the CG information. The additional network message may be marked as “3rd network message” for short. For instance, the 3rd network message may relate to DCI over a PDCCH. The DCI may include dynamic UL grant.

According to some embodiments, the SR is transmitted via an initial BWP or a dedicated BWP. In an embodiment, the dedicated BWP is configured by the network to be used in prior than other BWPs, for example, firstActiveUplinkBWP. For example, the SR is transmitted via the initial BWP, if the dedicated BWP is not already configured by the network.

According to some other embodiments, the SR is transmitted via a beam selected based on a beam measurement result after the SCG is deactivated. In an embodiment, the SR is transmitted on a beam of a best quality based on a beam measurement result after the SCG is deactivated.

In another embodiment, the operation of “the UE maintains the CG information” further comprises suspending or releasing the CG information in response to (1) an expiry of a TAT associated with the PSCell; (2) detecting a beam failure; and/or (3) detecting a RLF. For instance, after maintaining the CG information, the UE further suspends or releases the CG information in response to: an expiry of a TAT associated with the PSCell; detecting a beam failure; and/or detecting a RLF.

In yet another embodiment, the operation of “the UE maintains the CG information” further comprises transmitting the uplink data and/or a buffer status report (BSR) via an uplink transmission to the network via the CG information, if the CG information has not been released upon an arrival of uplink data at a radio bearer of the SCG. In an example, the uplink transmission is an initial BWP or a dedicated BWP. The dedicated BWP may be configured by the network to be used in prior than other BWPs, for example, firstActiveUplinkBWP. For instance, the uplink data and/or the BSR is transmitted via the initial BWP, if the dedicated BWP is not already configured by the network. In a further embodiment, the uplink transmission is a beam selected based on a beam measurement result after the SCG is deactivated. For instance, the uplink transmission is a beam of a best quality based on a beam measurement result after the SCG is deactivated.

Referring back to operation 201 of FIG. 2, in some embodiments, in response to receiving the CG information from the network, the UE may (re-)activate the SCG. In an embodiment, the operation of “the UE (re-)activates the SCG” further comprises triggering a random access (RA) procedure relating to the PSCell, in response to: (1) an expiry of a TAT associated with the PSCell; (2) detecting a beam failure; and/or (3) detecting a RLF.

Details described in all other embodiments of the present application (for example, details of receiving and/or handling CG information, e.g., Type 1 CG information) are applicable for the embodiments of FIG. 2. Moreover, details described in the embodiments of FIG. 2 are applicable for all the embodiments of FIGS. 1 and 3-7.

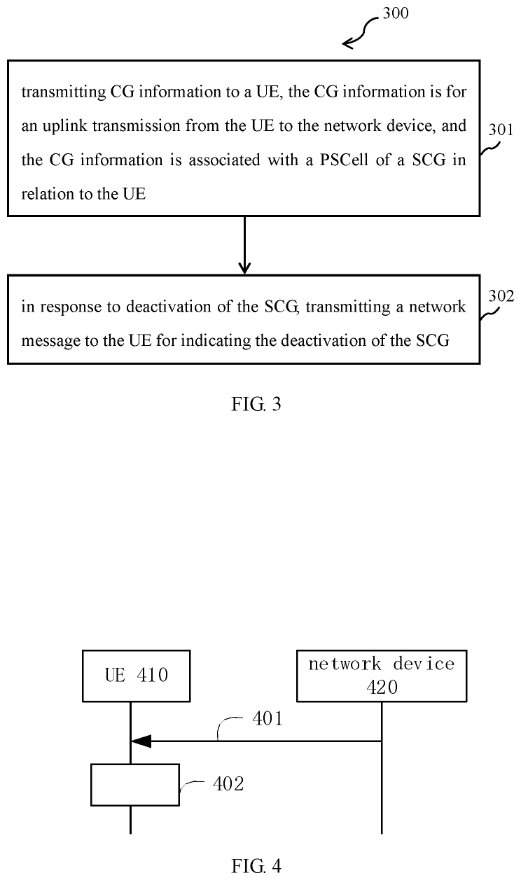

FIG. 3 illustrates an exemplary flow chart of a method for transmitting CG information in accordance with some embodiments of the present application. The exemplary method 300 in the embodiments of FIG. 3 may be performed by a network device (e.g., a MN and/or a SN). In some embodiments, the exemplary method 300 may be performed by MN 102, SN 103, network device 420, SN 520, MN 530, or network device 620 as shown and illustrated in any of FIGS. 1 and 4-6. Although described with respect to a network device (e.g., a MN and/or a SN), it should be understood that other devices may be configured to perform a method similar to that of FIG. 3. The embodiments of FIG. 3 assume that a MN and a SN may be combined in any one of EN-DC, NGEN-DC, NE-DC, and NR-DC scenarios.

In the exemplary method 300 as shown in FIG. 3, in operation 301, a network device (e.g., MN 102 and/or SN 103 as illustrated and shown in FIG. 1) transmits CG information to a UE (e.g., UE 101 as illustrated and shown in FIG. 1). The CG information is for an uplink transmission from the UE to the network device. The CG information is associated with a PSCell of a SCG in relation to the UE. According to some embodiments, the CG information relates to type 1 CG. That is, the network may transmit Type 1 CG information to the UE in operation 301. According to some other embodiments, the CG information relates to type 2 CG.

According to some embodiments, the CG information is transmitted to the UE in operation 301 in response to the SCG being (re-)activated. According to some other embodiments, the CG information is transmitted to the UE in operation 301 in response to at least one of:
(1) a TAT associated with the PSCell has not expired;
(2) a beam failure has not been detected;
(3) a RLF has not been detected; and
(4) the network device has not received SCG failure information transmitted from the UE.

In operation 302 as shown in FIG. 3, in response to deactivation of the SCG, the network device (e.g., MN 102 and/or SN 103 as illustrated and shown in FIG. 1) transmits a network message to the UE for indicating the deactivation of the SCG. According to some embodiments, in response to the SCG being deactivated, the network device stops transmission of the CG information to the UE.

According to some embodiments, the network device is a SN (e.g., SN 103 as illustrated and shown in FIG. 1), and the SN further transmits indication information to a MN (e.g., MN 102 as illustrated and shown in FIG. 1), and the indication information is for (re-)activating the SCG.

According to some embodiments, the network device transmits, to the UE, a further network message for deactivating the SCG. For instance, the further network message may be a RRC message. In an embodiment, the CG information is transmitted before the network device transmits the further network message. In another embodiment, the CG information is transmitted after the network device transmits the further network message. In some embodiments, after the UE receives the further network message from the network device, the CG information may be handled by the UE by at least one of:
(1) releasing the CG information;
(2) suspending the CG information; and
(3) maintaining the CG information.

According to some embodiments, the network device transmits, to the UE, a message for (re-)activating the SCG.

According to some embodiments, the network device receives a scheduling request (SR) from the UE. In an example, the SR is received on an initial BWP or a dedicated BWP (e.g., firstActiveUplinkBWP). The SR may be received on the initial BWP, if the dedicated BWP is not already configured by the network device. In a further example, the SR is received on a beam (e.g., a beam of a best quality) which is selected based on a beam measurement result after the SCG is deactivated. In some embodiments, in response to receiving the SR from the UE, the network device transmits an additional network message to the UE, and the additional network message indicates reinitialization of the CG information. For instance, the additional network message is DCI over a PDCCH. The DCI may include dynamic uplink (UL) grant.

According to some embodiments, the network device receives a message from the UE, and the message is received via the CG information. In response to receiving the message, the network device may (re-)activate the SCG. In an embodiment, the message received from the UE comprises uplink data and/or a BSR. In an embodiment, the message is received from the UE via an initial bandwidth part (BWP) or a dedicated BWP (e.g., firstActiveUplinkBWP). The message may be received from the UE on the initial BWP, if the dedicated BWP is not already configured by the network device. In a further embodiment, the message is received from the UE via a beam (e.g., a beam of a best quality) selected based on a beam measurement result after the SCG is deactivated.

Details described in all other embodiments of the present application (for example, details of transmitting and/or handling CG information, e.g., Type 1 CG information) are applicable for the embodiments of FIG. 3. Moreover, details described in the embodiments of FIG. 3 are applicable for all the embodiments of FIGS. 1, 2, and 4-7.

FIG. 4 illustrates an exemplary flowchart of handling CG information in accordance with some embodiments of the present application. The embodiments of FIG. 4 assume that CG information (e.g., at least Type 1 CG information) associated with a PSCell of a SCG has been configured to UE 410 and the CG information is not released before UE 410 receives signalling from network device 420 to deactivate the SCG.

As shown in FIG. 4, in operation 401, UE 410 (e.g., UE 101 as illustrated and shown in FIG. 1) receives signalling from network device 420 (e.g., MN 102 and/or SN 103 as illustrated and shown in FIG. 1) to deactivate a SCG in relation to UE 410.

In operation 402, upon receiving the signalling to deactivate the SCG from network device 420, UE 410 may handle CG information (e.g., Type 1 CG information) by adopting at least one of following three options:
(1) Option 1: UE 410 releases all CG information (e.g., Type 1 CG information) associated with a PSCell of the SCG.
   a) Optionally, UE 410 may release all CG information (e.g., Type 1 CG information) associated with SCell(s) of the SCG.
(2) Option 2: UE 410 suspends all CG information (e.g., Type 1 CG information) associated with the PSCell.
   a) Optionally, UE 410 may release all CG information (e.g., Type 1 CG information) associated with the PSCell upon an expiry of a TAT associated with the PSCell or upon detecting a beam failure or upon detecting a RLF.
   b) If the CG information (e.g., Type 1 CG information) is not released by UE 410 upon an expiry of a TAT or detecting a beam failure or detecting a RLF, the CG information will remain suspended.
(3) Option 3: UE 410 maintains all CG information (e.g., Type 1 CG information) associated the PSCell.
   a) Optionally, UE 410 may suspend or release all CG information (e.g., Type 1 CG information) associated with the PSCell upon an expiry of a TAT associated with the PSCell or upon detecting a beam failure or upon detecting a RLF.
   b) If the CG information (e.g., Type 1 CG information) is not suspended or released by UE 410 upon an expiry of a TAT or detecting a beam failure or detecting a RLF, CG information (e.g., Type 1 CG information) will remain available for uplink transmission.

In operation 402, UE 410 may deactivate the SCG. Any of Options 1-3 may be adopted during UE 410 deactivating the SCG or after UE 410 deactivates the SCG.

In some embodiments, in Option 2, if the CG information (e.g., Type 1 CG information) is not released and the deactivated SCG is (re-)activated by network device 420 or UE 410, the suspended CG information associated with the PSCell will be reinitialized via following operations:
(1) In a SCG (re-)activation procedure triggered by network device 420:
   a) Upon UE 410 receiving signaling from network device 420 to (re-)activate the SCG which has been deactivated, and the relevant TAT is still running, all CG information (e.g., Type 1 CG information) associated with the PSCell are reinitialized. UE 410 can use the CG information (e.g., Type 1 CG information) associated with the PSCell to send data in an uplink.
(2) In a SCG (re-)activation procedure triggered by UE 410:
   a) In case of uplink data arrival at a radio bearer of the deactivated SCG, and the relevant TAT is still running, UE 410 will send a scheduling request (SR) to network device 420. Then, the network device 420 may send signaling to UE 410 to reinitialize the suspended CG information (e.g., Type 1 CG information). In one example, upon receiving DCI over PDCCH from network device 420 (e.g., providing a dynamic uplink grant in response to the SR), all CG information (e.g., Type 1 CG information) associated with the PSCell are reinitialized by UE 410. UE 410 may send the SR via a BWP and/or a beam. For example:
      i. A BWP used to send the SR to network device 420 could be either the initial BWP, or a dedicated BWP (e.g., the firstActiveUplinkBWP) configured by network device 420.
      ii. A beam used to send the SR to network device 420 could be a beam of a best quality based on a beam measurement result after deactivation of the SCG.

In some embodiments, in Option 3, if the CG information (e.g., Type 1 CG information) is not released and uplink data arrives at a radio bearer of the deactivated SCG, UE 410 may simply use CG information (e.g., Type 1 CG information) to send data and/or a BSR. UE 410 may send the data and/or the BSR via a BWP and/or a beam. For example:
(1) A BWP used to send the data and/or the BSR to network device 420 could be either the initial BWP, or a dedicated BWP (e.g., the firstActiveUplinkBWP) configured by network device 420.
(2) A beam used to send the data and/or the BSR to network device 420 could be a beam of a best quality based on a beam measurement result after deactivation of the SCG.

Details described in all other embodiments of the present application (for example, details of handling CG information, e.g., Type 1 CG information) are applicable for the embodiments of FIG. 4. Moreover, details described in the embodiments of FIG. 4 are applicable for all the embodiments of FIGS. 1-3 and 5-7.

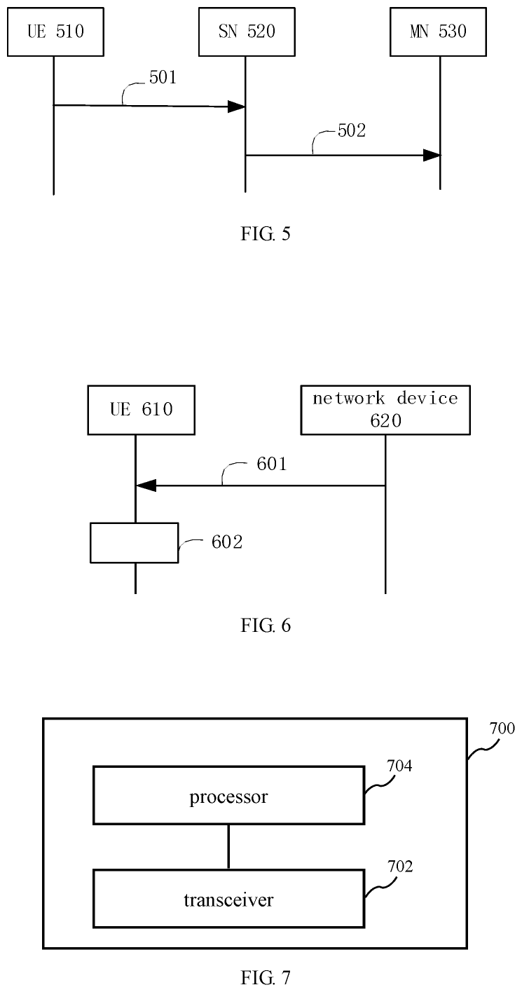

FIG. 5 illustrates a further exemplary flowchart of handling CG information in accordance with some embodiments of the present application. FIG. 5 illustrates some embodiments of abovementioned Options 2 and 3.

In particular, as shown in FIG. 5, in some embodiments of Options 2 and 3, in operation 501, UE 510 (e.g., UE 101 as illustrated and shown in FIG. 1) transmits a SR, data, and/or a BSR to SN 520 (e.g., SN 103 as illustrated and shown in FIG. 1). UE 510 uses CG information (e.g., Type 1 CG information) via a deactivated SCG. Upon receiving the SR, the data, and/or the BSR from UE 510, SN 520 considers that the (re-)activation of the SCG is triggered by UE 510.

In operation 502, SN 520 informs MN 530 (e.g., MN 102 as illustrated and shown in FIG. 1) about the SCG (re-)activation triggered by UE 510 via an explicit indicator in Xn message (e.g., a SN modification required message) sent from SN 520 to MN 530. The indicator for (re-)activation of the SCG triggered by UE 510 is different from an indicator for (re-)activation of the SCG triggered by SN 520.

Details described in all other embodiments of the present application (for example, details of handling CG information, e.g., Type 1 CG information) are applicable for the embodiments of FIG. 5. Moreover, details described in the embodiments of FIG. 5 are applicable for all the embodiments of FIGS. 1-4, 6, and 7.

FIG. 6 illustrates another exemplary flowchart of handling CG information in accordance with some embodiments of the present application. The embodiments of FIG. 6 assume that after a SCG in relation to UE 610 is deactivated, network device 620 might provide CG information (e.g., Type 1 CG information) associated with a PSCell of the SCG to UE 610.

In particular, as shown in FIG. 6, in operation 601, after a SCG in relation to UE 610 is deactivated, UE 610 (e.g., UE 101 as illustrated and shown in FIG. 1) receives, from network device 620, CG information (e.g., Type 1 CG information) associated with a PSCell of the SCG via RRC signalling. In operation 602, upon receiving the CG information from network device 620, UE 610 may handle the CG information by adopting at least one of following three options:
(1) Option A: UE 610 ignores and clears the CG information provided by network device 620.
   a) Optionally, UE 610 may clear all CG information (e.g., Type 1 CG information) associated with SCell(s) of the SCG. In one embodiment, UE 610 only ignores and clears the CG information provided by network device 620 upon an expiry of a TAT associated with the PSCell of the SCG or upon detecting a beam failure or upon detecting a RLF.
(2) Option B: UE 610 stores the received CG information as suspended CG information.
   a) Optionally, UE 610 may clear all CG information associated with the PSCell of the SCG upon an expiry of a TAT associated with the PSCell or detecting a beam failure or detecting a RLF.
(3) Option C: UE 610 maintains the received CG information.
   a) Optionally, UE 610 may clear all CG information associated with the PSCell of the SCG upon an expiry of a TAT associated with the PSCell or detecting a beam failure or detecting a RLF.

In some embodiments, in Option B, if the CG information (e.g., Type 1 CG information) is not cleared and the deactivated SCG is (re-)activated by network device 620 or UE 610, the suspended CG information associated with the PSCell will be reinitialized as follows:
(1) In a SCG (re-)activation procedure triggered by network device 620:
   b) Upon UE 610 receiving signaling from network device 620 to (re-)activate the SCG which has been deactivated, and the relevant TAT is still running, all CG information (e.g., Type 1 CG information) associated with the PSCell are reinitialized. UE 610 can use the CG information (e.g., Type 1 CG information) associated with the PSCell to send data in an uplink.
(2) In a SCG (re-)activation procedure triggered by UE 610:
   a) In case of uplink data arrival at a radio bearer of the deactivated SCG, and the relevant TAT is still running, UE 610 will firstly send a scheduling request (SR) to network device 620. Then, the network device 620 may send signaling to UE 610 to reinitialize the suspended CG information (e.g., Type 1 CG information). In one example, upon receiving DCI over PDCCH from network device 620 (e.g., providing a dynamic uplink grant in response to the SR), all CG information (e.g., Type 1 CG information) associated with the PSCell are reinitialized by UE 610. UE 610 may send the SR via a BWP and/or a beam. For example:
      i. A BWP used to send the SR to network device 620 could be either the initial BWP, or a dedicated BWP (e.g., the firstActiveUplinkBWP) configured by network device 620.
      ii. A beam used to send the SR to network device 620 could be a beam of a best quality based on a beam measurement result after deactivation of the SCG.

In some embodiments, in Option C, if the CG information (e.g., Type 1 CG information) is not cleared and uplink data arrives at a radio bearer of the deactivated SCG, UE 610 may simply use CG information (e.g., Type 1 CG information) to send data and/or a BSR. UE 610 may send the data and/or the BSR via a BWP and/or a beam. For example:
(1) A BWP used to send the data and/or the BSR to network device 620 could be either the initial BWP, or a dedicated BWP (e.g., the firstActiveUplinkBWP) configured by network device 620.
(2) A beam used to send the data and/or the BSR to network device 620 could be a beam of a best quality based on a beam measurement result after deactivation of the SCG.

In some embodiments, when UE 610 receives the CG information (e.g., Type 1 CG information) associated with the PSCell of the SCG in operation 601, it implicitly means network device 620 triggered (re-)activation of the SCG, and UE 610 shall perform steps to (re-)activate the SCG. For example, UE 610 may start a random access (RA) procedure to the PSCell, if a TAT associated with the PSCell has expired or if a beam failure or a RLF has been detected.

In some embodiments, network device 620 can provide the CG information (e.g., Type 1 CG information) associated with the PSCell of deactivated SCG only if at least one of following conditions is fulfilled:

(1) A TAT associated with the PSCell has not expired.

(2) A beam failure or a RLF has been detected.

(3) Network device 620 has not received SCG failure information sent from UE 610.

In some embodiments, from a viewpoint of network device 620, if network device 620 is a SN, the SN may not provide the CG information (e.g., Type 1 CG information) associated with the PSCell of the SCG if the SCG is deactivated.

Details described in all other embodiments of the present application (for example, details of handling CG information, e.g., Type 1 CG information) are applicable for the embodiments of FIG. 6. Moreover, details described in the embodiments of FIG. 6 are applicable for all the embodiments of FIGS. 1-5 and 7.

FIG. 7 illustrates an exemplary block diagram of an apparatus according to some embodiments of the present application. As shown in FIG. 7, the apparatus 700 may include at least one processor 704 and at least one transceiver 702 coupled to the processor 704. The apparatus 700 may be a UE or a network device (e.g., a MN and/or a SN).

Although in this figure, elements such as the at least one transceiver 702 and processor 704 are described in the singular, the plural is contemplated unless a limitation to the singular is explicitly stated. In some embodiments of the present application, the transceiver 702 may be divided into two devices, such as a receiving circuitry and a transmitting circuitry. In some embodiments of the present application, the apparatus 700 may further include an input device, a memory, and/or other components.

In some embodiments of the present application, the apparatus 700 may be a UE. The transceiver 702 may be configured to receive CG information from a network, wherein the CG information is for an uplink transmission from the UE to the network, and wherein the CG information is associated with a PSCell of a SCG in relation to the UE. In response to deactivation of the SCG, the processor 704 may be configured to handle the CG information by at least one of: releasing the CG information from the UE; suspending the CG information in the UE; and maintaining the CG information in the UE.

In some embodiments of the present application, the apparatus 700 may be a network device (e.g., a MN and/or a SN). The transceiver 702 may be configured to transmit CG information to a UE, wherein the CG information is for an uplink transmission from the UE, wherein the CG information is associated with a PSCell of a SCG in relation to the UE. The transceiver 702 may be configured to transmit a network message to the UE for indicating deactivation of the SCG, in response to the deactivation of the SCG.

In some embodiments of the present application, the apparatus 700 may further include at least one non-transitory computer-readable medium. In some embodiments of the present disclosure, the non-transitory computer-readable medium may have stored thereon computer-executable instructions to cause a processor to implement the method with respect to a UE or a network device (e.g., a MN and/or a SN) as described above. For example, the computer-executable instructions, when executed, cause the processor 704 interacting with transceiver 702, so as to perform operations of the methods, e.g., as described in view of any of FIGS. 2-6.

While this disclosure has been described with specific embodiments thereof, it is evident that many alternatives, modifications, and variations may be apparent to those skilled in the art. For example, various components of the embodiments may be interchanged, added, or substituted in the other embodiments. Also, all of the elements of each figure are not necessary for operation of the disclosed embodiments. For example, those having ordinary skills in the art would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The term “having” and the like, as used herein, are defined as “including.

What is claimed is:

1. A user equipment (UE) for wireless communication, comprising:
at least one memory; and
at least one processor coupled with the at least one memory and configured to cause the UE to:
receive configured grant (CG) information from a network, the CG information is being for an uplink transmission from the UE to the network, and the CG information being associated with a primary secondary cell (PSCell) of a secondary cell group (SCG) in relation to the UE; and
handle, in response to deactivation of the SCG, the CG information including at least one of:
release the CG information from the UE;
suspend the CG information in the UE; and/or
maintain the CG information in the UE.

2. The UE of claim 1, wherein one or more of:
to release the CG information further comprises to release additional CG information, wherein the additional CG information is associated with one or more secondary cells (SCells) of the SCG; or
to suspend the CG information further comprises to release the CG information in response to at least one of:
an expiry of a time alignment timer (TAT) associated with the PSCell;
detecting a beam failure; or
detecting a radio link failure (RLF); or
to maintain the CG information further comprises to suspend or release the CG information in response to at least one of:
the expiry of the TAT associated with the PSCell;
detecting the beam failure; or
detecting the RLF.

3. The UE of claim 1, wherein:
to suspend the CG configuration information further comprises, if the CG information is not released from the UE, to reinitialize the CG information.

4. The UE of claim 3, wherein the CG information is reinitialized in response to at least one of:
receive a second network message from the network, and determining that a TAT associated with the PSCell is running, wherein the second network message includes a command for reactivating the SCG; or
an arrival of uplink data at a radio bearer of the SCG, and to determine that the TAT associated with the PSCell is running.

5. The UE of claim 3, wherein the at least one processor is configured to cause the UE to:
transmit a scheduling request (SR) to the network; and
receive a third network message from the network, wherein the third network message indicates reinitialization of the CG information.

6. The UE of claim 1, wherein:
to maintain the CG configuration information further comprises to transmit, if the CG information has not been released upon an arrival of uplink data at a radio bearer of the SCG, at least one of the uplink data and a buffer status report (BSR) via an uplink transmission to the network via the CG information.

7. The UE of claim 1, wherein the at least one processor is configured to cause the UE to:
activate, in response to receiving the CG information, the SCG.

8. A network device for wireless communication, the network device comprising:
at least one memory; and
at least one processor coupled with the at least one memory and configured to cause the network device to:
transmit configured grant (CG) information to a user equipment (UE), the CG information being for an uplink transmission from the UE to the network device, and the CG information being associated with a primary secondary cell (PSCell) of a secondary cell group (SCG) in relation to the UE; and
transmit, in response to deactivation of the SCG, a first network message to the UE for indicating the deactivation of the SCG.

9. The network device of claim 8, wherein the at least one processor is configured to cause the network device to:
stop, in response to the SCG being deactivated, transmission of the CG information to the UE.

10. The network device of claim 8, wherein the CG information is transmitted to the UE in response to the SCG being reactivated.

11. The network device of claim 8, wherein the at least one processor is configured to cause the network device to:
receive a scheduling request (SR) from the UE.

12. The network device of claim 11, wherein the at least one processor is configured to cause the network device to:
transmit, in response to receiving the SR from the UE, a third network message to the UE, wherein the third network message indicates reinitialization of the CG information.

13. The network device of claim 8, wherein the at least one processor is configured to cause the network device to:
receive a message from the UE, wherein the message is received via the CG information; and
reactivate, in response to receiving the message, the SCG.

14. (canceled)

15. (canceled)

16. A processor for wireless communication, comprising:
at least one controller coupled with at least one memory and configured to cause the processor to:
receive configured grant (CG) information from a network, the CG information being for an uplink transmission from a user equipment (UE) to the network, and the CG information being associated with a primary secondary cell (PSCell) of a secondary cell group (SCG) in relation to the UE; and
handle, in response to deactivation of the SCG, the CG information including at least one of:
release the CG information from the UE;
suspend the CG information in the UE; or
maintain the CG information in the UE.

17. The processor of claim 16, wherein one or more of:
to release the CG information further comprises to release additional CG information, wherein the additional CG information is associated with one or more secondary cells (SCells) of the SCG; or
to suspend the CG information further comprises to release the CG information in response to at least one of:
an expiry of a time alignment timer (TAT) associated with the PSCell;
detecting a beam failure; or
detecting a radio link failure (RLF); or
to maintain the CG information further comprises to suspend or release the CG information in response to at least one of:
the expiry of the TAT associated with the PSCell;
detecting the beam failure; or
detecting the RLF.

18. The processor of claim 16 wherein:
to suspend the CG configuration information further comprises, if the CG information is not released from the UE, to reinitialize the CG information.

19. The processor of claim 18, wherein the CG information is reinitialized in response to one of:
to receive a second network message from the network, and determine that a TAT associated with the PSCell is running, wherein the second network message includes a command for reactivating the SCG; or
an arrival of uplink data at a radio bearer of the SCG, and to determine that the TAT associated with the PSCell is running.

20. The processor of claim 18 wherein the at least one controller is configured to cause the processor to:
transmit a scheduling request (SR) to the network; and
receive a third network message from the network, wherein the third network message indicates reinitialization of the CG information.

21. The processor of claim 16, wherein:
to maintain the CG configuration information further comprises to transmit, if the CG information has not been released upon an arrival of uplink data at a radio bearer of the SCG, at least one of the uplink data and a buffer status report (BSR) via an uplink transmission to the network via the CG information.

22. A method performed by a user equipment (UE), the method comprising:
receiving configured grant (CG) information from a network, the CG information being for an uplink transmission from the UE to the network, and the CG information being associated with a primary secondary cell (PSCell) of a secondary cell group (SCG) in relation to the UE; and
handling, in response to deactivation of the SCG, the CG information by at least one of:
releasing the CG information from the UE;
suspending the CG information in the UE; or
maintaining the CG information in the UE.
